(19) United States
(12) Patent Application Publication
(10) Pub. No.: US 2026/0034690 A1
(43) Pub. Date: Feb. 5, 2026

(54) CUTTER HEAD ASSEMBLY OF NOSE HAIR TRIMMER

(71) Applicant: LITTLE STONE CERAMIC BLADE (ZHONGSHAN ) COMPANY LTD., Zhongshan (CN)

(72) Inventors: Rangpan Wu, Zhongshan (CN); Guande Wei, Zhongshan (CN)

(21) Appl. No.: 19/351,300

(22) Filed: Oct. 7, 2025

Related U.S. Application Data
(63) Continuation-in-part of application No. PCT/CN2024/089727, filed on Apr. 25, 2024.

(30) Foreign Application Priority Data
Apr. 28, 2023 (CN) 202321019062.8
Sep. 22, 2023 (CN) 202322606406.1
Mar. 27, 2025 (CN) 202520569742.X

(51) Int. Cl. B26B 19/14; B26B 19/16

(52) U.S. Cl. CPC B26B 19/148; B26B 19/16

(57) ABSTRACT

A cutter head assembly of a nose hair trimmer, comprising a fixed cutter and a movable cutter assembly, wherein the fixed cutter comprises a fixed cutter body, a plurality of cutting teeth are provided on the fixed cutter body at intervals in a circumferential direction, the cutting teeth enclose a cutting cavity for the movable cutter assembly to move inside, and a hair inlet hole is formed between the cutting teeth, the hair inlet hole comprises a narrow slot located at a lower portion, and a wide opening located at an upper portion which is wider than the narrow slot. The disclosure improves nose hair trimming efficiency, reduces jamming, and improves user safety.

### CROSS REFERENCE TO RELATED APPLICATIONS

The present application is a Continuation-In-Part Application of PCT Application No. PCT/CN2024/089727 filed on Apr. 25, 2024, which claims the benefit of Chinese Patent Application Nos. 202321019062.8 filed on Apr. 28, 2023 and 202322606406.1 filed on Sep. 22, 2023. The present application also claims the benefit of Chinese Patent Application No. 202520569742.X filed on Mar. 27, 2025. All the above are hereby incorporated by reference in their entirety.

### TECHNICAL FIELD

The present disclosure relates to a cutter head assembly of a nose hair trimmer.

### BACKGROUND ART

In the existing nose hair trimmers, the nose hair trimming head is generally composed of a fixed cutter and an inner cutter assembly, wherein the fixed cutter covers the inner cutter assembly on the inner side, and a slit is provided on the fixed cutter to allow the nose hair to enter for cutting.

A built-in rotary nose hair shearing device is disclosed in the publication No. CN202162825U. While the nose hair grows in different directions in the nostrils, when the nose hair trimming head is inserted into the nostrils to trim the nose hair, it is difficult for the nose hair to be cut into the slit, and it usually takes a long time to continuously rotate the nose hair trimming head in order to expect the nose hair to be trimmed into the slit. In addition, the fixed cutter is generally of a cylindrical structure and has a certain conicity, the upper portion is small and the lower portion is large; when the nose hair trimming head is inserted into the nostril, the lower portion of the fixed cutter is blocked at the position of the inlet of the nostril, affecting the rotation range of the nose hair trimming head in the nostril, affecting the nose hair entering the slit.

In addition, the existing movable cutter assembly includes a movable cutter holder, a blade and a spring, and the blade is elastically opened and pressed against the inner wall of the fixed cutter by the spring; since the transmission structure of the movable cutter holder is at the lower end, when the lower end of the movable cutter holder is connected to the transmission output shaft of the motor and rotates, the movable cutter holder will eccentrically rotate, and the two blades at the upper end are elastically holdered on the side surface of the fixed cutter, and can elastically expand and contract; therefore, when the whole movable cutter assembly rotates at a high speed, the upper portion thereof is very easy to generate different movement conditions, such as play, swing and rotation, etc. and the blade is not stable enough when rotating against the inner wall of the fixed cutter. As a result, noises, murmurs, jams, poor shearing acuteness, and other undesirable phenomena are easily generated.

The present disclosure has been made in view of this situation.

### SUMMARY OF THE INVENTION

The technical problem to be solved by the present disclosure is to provide a cutter head assembly of a nose hair trimmer which has a simple structure and a high hair inletting efficiency.

In order to solve the above technical problem, the technical solution adopted by the present disclosure is as follows.

A cutter head assembly of a nose hair trimmer, including a fixed cutter and a movable cutter assembly, wherein the fixed cutter includes a fixed cutter body, a plurality of cutting teeth are provided on the fixed cutter body at intervals in a circumferential direction, the cutting teeth enclose a cutting cavity for the movable cutter assembly to move inside, and a hair inlet hole is formed between the cutting teeth, the hair inlet hole includes a narrow slot located at a lower portion, and a wide opening located at an upper portion which is wider than the narrow slot.

According to the cutter head assembly of a nose hair trimmer as described above, wherein the cutting teeth include a long cutter tooth and a short cutter tooth, a plurality of short cutter teeth are provided between two adjacent long cutter teeth, a head portion of the short cutter teeth is a free end, and the hair inlet hole is formed between the two adjacent long cutter teeth, wherein the short cutter teeth form the narrow slot with the adjacent long cutter teeth or short cutter teeth at left and right sides thereof, and the two long cutter teeth form the wide opening above the head portion of the short cutter teeth.

According to the cutter head assembly of a nose hair trimmer as described above, wherein an upper end of the long cutter tooth is bent inward toward a central axis and divides the long cutter tooth into a fixed cutter side section and a fixed cutter top section.

According to the fixed cutter of the present disclosure, the fixed cutter top sections are connected together by a net top.

According to the fixed cutter of the present disclosure, the short cutter teeth are wider than the long cutter teeth.

According to the fixed cutter of the present disclosure, the fixed cutter top section is downwardly concave with respect to the fixed cutter side section.

According to the fixed cutter of the present disclosure, the short cutter teeth are shorter than the fixed cutter side section.

According to the fixed cutter of the present disclosure, the short cutter teeth have their head portions facing inwards.

According to the fixed cutter of the present disclosure, the fixed cutter has smaller upper and lower portions and a larger middle portion.

According to the fixed cutter of the present disclosure, a middle portion of an outer wall of the fixed cutter body has a concave waist portion.

According to the fixed cutter of the present disclosure, the cutting teeth are provided with acute cutting edges.

According to the fixed cutter of the present disclosure, the fixed cutter is formed by powder metallurgy.

According to the cutter head assembly of the present disclosure, wherein a net top is provided at the top of the fixed cutter, and a center positioning structure is provided between the net top and the movable cutter assembly for centering the movable cutter assembly when it is rotated.

The cutter head assembly of a nose hair trimmer as described above, wherein the center positioning structure includes a center positioning hole and a positioning post fitted between the net top and the movable cutter holder.

The cutter head assembly of a nose hair trimmer as described above, wherein the net top is provided with a positioning post facing downwards, and the movable cutter holder is provided with a center positioning hole; or the net top is provided with a center positioning hole, and the movable cutter holder is provided with a positioning post facing upwards.

The cutter head assembly of a nose hair trimmer as described above, further including a housing for mounting the fixed cutter, a middle upper portion of the fixed cutter being exposed above the housing, and a middle portion of the fixed cutter being larger than an upper portion of the housing.

The cutter head assembly of a nose hair trimmer as described above, wherein the fixed cutter is provided with a mounting portion at a lower end, the mounting portion is provided with a snap hole and a positioning groove, the housing is provided with an insertion groove into which the mounting portion is inserted from above to below at an upper end, the insertion groove is provided with a snap which protrudes and is used for snapping into the snap hole, and a positioning strip for inserting into the positioning groove.

The cutter head assembly of the present disclosure further including a housing for mounting the fixed cutter, wherein a middle portion of an outer wall of the fixed cutter body has a concave waist portion, and the cutting cavity is a straight hole or a hole with a small upper portion and a large lower portion penetrating downward, a lower end of the fixed cutter body is provided with a mounting portion, and an upper end of the housing is provided with an insertion groove into which the mounting portion is inserted from top to bottom, and the mounting portion is inserted and fixed in the insertion groove.

According to the cutter head assembly of the present disclosure, wherein the movable cutter assembly includes a movable cutter holder and a blade mounted on the movable cutter holder, the blade being attached to the inner side wall of the fixed cutter and cooperating with the cutting teeth when rotated to cut hair into the narrow slots.

According to the cutter head assembly of the present disclosure, wherein a plurality of the cutting teeth are bent inward toward a central axis at their upper ends so that the respective cutting teeth are divided into a fixed cutter side section and a fixed cutter top section, the inner ends of the fixed cutter top section being connected together by a net top, the fixed cutter top section being recessed downward with respect to the fixed cutter side section and enclosing a groove recessed inward from top to bottom, and two adjacent the fixed cutter top sections are spaced apart to form a part of the hair inlet hole, so that the hair inlet hole communicates with the groove, a side cutting edge of the blade for cutting hairs cooperating with the cutting teeth is located between the fixed cutter side sections and the net top, and an upper end of the side cutting edge of the blade is higher than the net top.

Compared to the prior art, the present disclosure has the following advantages:
1. The present disclosure improves the safety of cutting by dividing the hair inlet hole into two parts, namely, a wide opening at the upper portion and a narrow slot at the lower portion, wherein the position of the narrow slot is used for cutting hair corresponding to the blade in an internal rotation movement, and by providing the narrow slot to cooperate with the blade; the wide opening facilitates entry of the nose hair when the fixed cutter is moved within the nostril, including, but not limited to, rotating, swinging, and/or moving in and out of the nostril, and when the nose hair enters the wide opening, the nose hair is easily moved further from the wide opening into the narrow slot, thereby increasing the probability that the nose hair will enter the cutting position for cutting.
2. Through the combination of the long and short cutter teeth, when the appropriate width of the narrow slot is ensured, the wide opening can have a greater width, and one wide opening corresponds to more than two narrow slots at the same time, improving the efficiency of the nose hair entering the narrow slot from the wide opening, and improving the efficiency of shearing.
3. The top section of the fixed cutter is connected by the net top, and the structure strength of the long cutter tooth is good, which is beneficial to make the long cutter tooth thinner, and improve the efficiency of the hair inletting. The width of the short cutter teeth is greater than the long cutter teeth, increasing the strength of the short cutter teeth.
4. The top section of the fixed cutter is recessed downwardly relative to the side section of the fixed cutter so that the long cutter teeth are relatively raised at the juncture of the turns of the side section of the fixed cutter and the top section of the fixed cutter to facilitate the combing of the nose hair into the wide opening.
5. The fixed cutter has smaller upper and lower portions and a larger middle portion, so as to facilitate the fixed cutter to rotate and agitate in multiple angles in the nostrils after being inserted into the nostrils, so as to better make the nose hairs enter the narrow slots for cutting; furthermore, a middle portion of an outer wall of the fixed cutter is provided with an inner concave waist portion, so as to facilitate the rotation of the fixed cutter, at the same time, the outer diameter below the waist portion of the fixed cutter can be increased, facilitating the outer arrangement of the mounting portion, so as to avoid the hole diameter of the inner cavity at the position corresponding to the mounting portion from being reduced, so that when the outer diameter of the waist portion and the upper portion of the fixed cutter is made to be constant, the hole diameter of the inner cavity thereof is not too small, avoiding affecting the movable cutter assembly.
6. The acute cutting edge is provided on the cutting teeth to improve the cutting acuteness, and the powder metallurgy forming process is conducive to the formation of acute cutting edge; at the same time, when the cutting cavity is provided as a straight hole or a tapered hole with a small upper portion and a large lower portion, it is possible to reduce the processing difficulty of the powder metallurgy forming.
7. According to the present disclosure, a positioning structure is provided between the net top and the movable cutter assembly so as to enable the movable cutter assembly to be centrally positioned during rotation, so as to improve the stability of the movable cutter assembly during rotation, reduce undesirable phenomena such as noise, murmur, and jams, and improve the shearing acuteness.
8. In the present disclosure, the inner ends of the top section of the fixed cutter are connected together by a net top, the top section of the fixed cutter is recessed downwards with respect to the side section of the fixed cutter and encloses a concave groove from top to bottom, the hair inlet hole is in communication with the groove, and the side cutting edge on the blade is located between the side section of the fixed cutter and the net top, when trimming the nose hairs, the fixed cutter is inserted into the nostril, and after the transversely growing nose hairs enter the hair inlet hole, the nose hairs can fall downwards via the concave groove, and when the nose hairs fall on the net top and are stopped by the net top, an upper end of the side cutting edge is higher than the net top, so that the nose hairs stopped by the net top can easily fall within the cutting range of the side cutting edge. So that the nose hair is cut away and the efficiency of trimming the nose hair is improved.

### BRIEF DESCRIPTION OF THE DRAWINGS

FIG. 1 is a schematic view showing a structure of a nose hair trimmer according to the present disclosure;

FIG. 2 is a schematic view showing a structure of a first embodiment of a fixed cutter having long cutter teeth and short cutter teeth according to the present disclosure;

FIG. 3 is a schematic view showing a structure of a second embodiment of a fixed cutter having long cutter teeth and short cutter teeth according to the present disclosure;

FIG. 4 is a schematic view showing a structure of an embodiment of a fixed cutter in which the upper end of a long cutter tooth is a free end;

FIG. 5 is a schematic view showing an embodiment structure in which two short cutter teeth are provided between two long cutter teeth;

FIG. 6 and FIG. 7 are schematic views showing structures of embodiments in which a hair inlet hole is formed by only two cutting teeth, respectively;

FIG. 8 is a schematic view showing a structure in which the cutting edge of the fixed cutter is formed at an acute angle;

FIG. 9 is a schematic view showing a structure taken along the line A-A of FIG. 8;

FIG. 10 is a schematic view of the movable cutter assembly in engagement with the fixed cutter;

FIG. 11 is a schematic view showing a structure of a cutter head assembly assembled with a housing for a fixed cutter having a concave waist portion;

FIG. 12 is a schematic view showing a structure taken along the line B-B of FIG. 11;

FIG. 13 is a schematic view showing a structure of one embodiment of a cutter head assembly;

FIG. 14 is an exploded view showing a structure of one embodiment of a cutter head assembly;

FIG. 15 is a cross-sectional view of a center positioning structure of a cutter head assembly according to the present disclosure;

FIG. 16 is a cross-sectional view of another center positioning structure of a cutter head assembly according to the present disclosure;

FIG. 17 is a schematic view showing a structure of another embodiment of a cutter head assembly according to the present disclosure;

FIG. 18 is a cross-sectional view showing a structure taken along the line C-C of FIG. 17.

### DETAILED DESCRIPTION OF THE INVENTION

The present disclosure will now be further described with reference to the accompanying drawings in which:

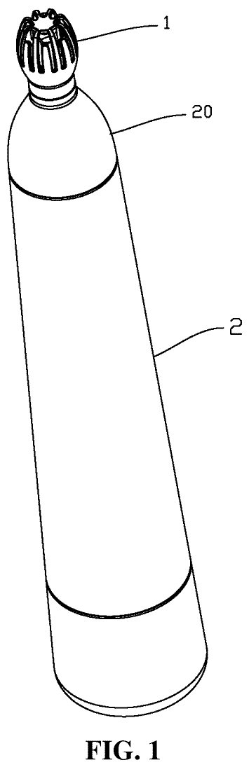

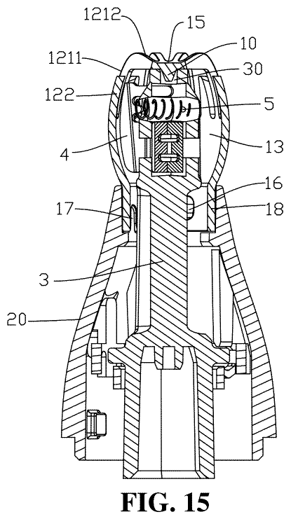

As shown in FIGS. 1 to 18, a fixed cutter 1 of a nose hair trimmer includes a fixed cutter body, a plurality of cutting teeth are provided on the fixed cutter body at intervals in a circumferential direction, the cutting teeth enclose a cutting cavity for the movable cutter assembly to move inside, and a hair inlet hole is formed between the cutting teeth, the hair inlet hole includes a narrow slot located at a lower portion, and a wide opening located at an upper portion which is wider than the narrow slot. The position of the narrow slot 141 is used for cutting hair corresponding to the blade in an internal rotation movement, and by providing the narrow slot 141 to cooperate with the blade, the safety of cutting is improved; when the fixed cutter 1 is moved within the nostril, including but not limited to rotating, swinging, and/or moving in and out of the nostril, the wide opening 142 facilitates the entry of the nose hair, and when the nose hair enters the wide opening 142, the nose hair is easily moved further from the wide opening 142 into the narrow slot 141, thereby increasing the probability that the nose hair enters the cutting position for cutting.

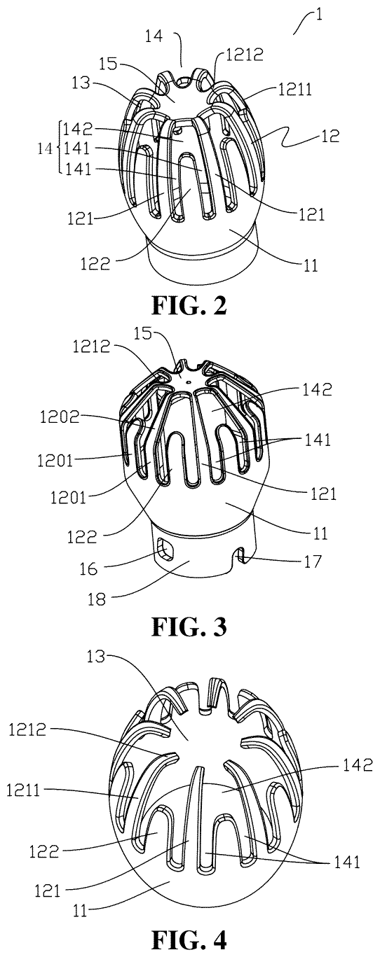

As an embodiment of the cutting tooth 12, as shown in FIGS. 2 to 5, 13 and 17, the cutting tooth 12 includes a long cutter tooth 121 and a short cutter tooth 122, a plurality of short cutter teeth 122 are provided between two adjacent long cutter teeth 121, a head portion of the short cutter tooth 122 is a free end, and the hair inlet hole 14 is formed between the two adjacent long cutter teeth 121, wherein the short cutter tooth 122 forms a slot 141 with the adjacent long cutter tooth 121 or the short cutter tooth 122 at left and right sides thereof, and the two long cutter teeth 121 form a wide opening 142 above the head portion of the short cutter tooth 122.

Through the combination of the long and short cutter teeth, when the appropriate width of the narrow slot 141 is ensured, the wide opening 142 can have a larger width, and one wide opening 142 corresponds to more than two narrow slots 141 at the same time, improving the efficiency of the nose hair entering the narrow slot 141 from the wide opening 142, and improving the efficiency of shearing.

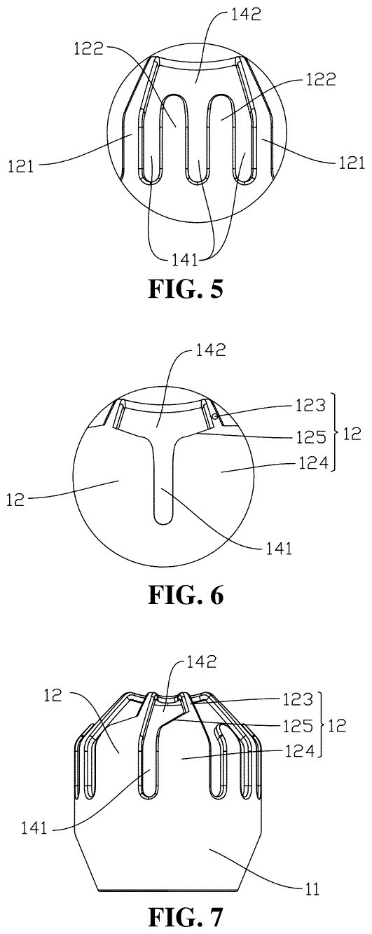

As shown in the embodiment of FIGS. 2 to 4, a short cutter tooth 122 is provided between two adjacent long cutter teeth 121, and a wide opening 142 of the short cutter tooth 122 corresponds to two narrow slots 141 at the same time, and the width of the wide opening 142 is more than twice the width of the narrow slots 141. As shown in the embodiment of FIG. 5, two short cutter teeth 122 are provided between two adjacent long cutter teeth 121, one wide opening 142 of which corresponds to three slots 141 at the same time, the wide opening 142 is larger, and the width of the wide opening 142 is more than three times the width of the narrow slots 141.

An upper end of the long cutter tooth 121 is bent inward toward a central axis, and divides the long cutter tooth 121 into a fixed cutter side section 1211 and a fixed cutter top section 1212.

As shown in FIG. 2 and FIG. 3, the fixed cutter top section 1212 is connected together by the net top 15, and the long cutter teeth 121 have a good structure strength, so that the long cutter teeth 121 can be made thinner and the efficiency of feeding wool can be improved. The width of the short cutter teeth 122 is greater than the long cutter teeth 121, increasing the strength of the short cutter teeth 122. Of course, as shown in FIG. 4, the long cutter tooth 121 is fixed at its lower end and free at its upper end, and a plurality of the fixed cutter top sections 1212 define a gap at the top, which is communicated with the wide opening 142, so that it is easier to stab the nose hair into the wide opening 142.

As shown in FIGS. 2 to 4, the fixed cutter top section 1212 is recessed downwardly relative to the fixed cutter side section 1211 such that the net top 15 is recessed downwardly from the top of the fixed cutter 1 so that the long cutter teeth 121 are relatively raised at the juncture of the turns of the fixed cutter side section 1211 and the fixed cutter top section 1212 to facilitate the combing of the nose hair into the wide opening 142.

As shown in FIGS. 2 to 4, the short cutter teeth 122 are shorter than the side sections 1211 of the fixed cutter, and the wide opening 142 covers the upper portion of the side sections 1211 of the fixed cutter, the juncture of the turns of the side sections 1211 of the fixed cutter and the top section 1212 of the fixed cutter, and the top section 1212 of the fixed cutter, so as to facilitate the passage of the nose hair into the wide opening 142 when the fixed cutter is poked into the nostril or when the fixed cutter is agitated in the nostril.

The fixed cutter is small up and down and large in the middle, so as to facilitate the fixed cutter to rotate and agitate in the nostrils in multiple angles after being inserted into the nostrils, so as to make the nose hair cut into the narrow slot 141 better.

The short cutter teeth 122 have their heads facing inwardly to better protect the movable cutter assembly therein and also to better prevent the ends of the short cutter teeth 122 from touching the inner walls of the nostrils when inserted obliquely into the nostrils.

As shown in the embodiment of FIG. 3, the fixed cutter side section 1211 includes a straight section 1201 and a deflected section 1202 which is deflected inwardly with respect to the straight section 1201, and the short cutter tooth 122 includes a corresponding straight section 1201, and the upper end of the straight section 1201 of the short cutter tooth 122 is provided with a head which is deflected inwardly. Alternatively, as in the embodiment shown in FIG. 2, the fixed cutter side section 1211 and the short cutter tooth 122 are arcuate, with the upper end of the short cutter tooth 122 being offset to the inside.

As a second embodiment of the cutting tooth 12, as shown in FIGS. 6 and 7, the cutting tooth 12 includes an upper thin section 123 and a lower thick section 124, and an inclined section 125 inclined from the thin section 123 to the thick section 124, and the two cutting teeth 12 form a wide opening 142 between the thin sections 123 and a slot 141 between the thick sections 124, which has a small number of teeth, a simple structure, and is easy to manufacture. As shown in FIG. 6, the narrow slot 141 can be located below the middle of the wide opening 142; of course, as shown in FIG. 7, the narrow slot 141 may be located below one side of the wide opening 142.

As shown in FIG. 7, the cutting teeth 12 on the fixed cutter 1 may also be a combination of the first and second embodiments described above.

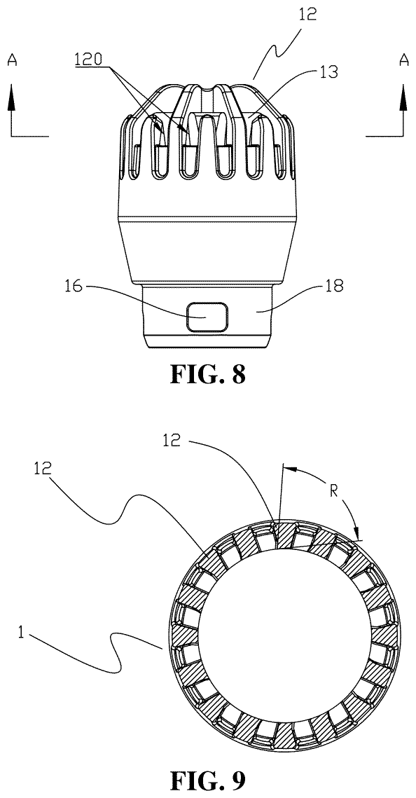

In a preferred embodiment of the present disclosure, as shown in FIGS. 8-9, the cutting tooth 12 is provided with an acute cutting edge 120 having an angle R≤85°, which is beneficial for improving the sharpness of cutting. Further, in order to facilitate the formation of an acute cutting edge, the fixed cutter 1 is preferably formed by powder metallurgy, and the cutting cavity 13 thereof may be integrally formed by powder metallurgy or may be formed by turning or milling after the powder metallurgy forming of the fixed cutter 1.

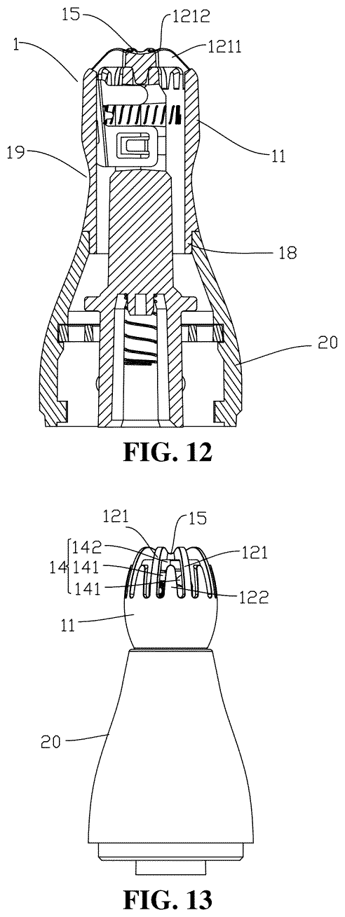

As shown in FIGS. 11 and 12, in order to enable the fixed cutter 1 to better rotate and agitate at multiple angles in the nostrils, an inner concave waist portion 19 is provided in the middle part of the outer wall of the fixed cutter body 11, and the inner cavity thereof is a straight hole or a hole with a small upper portion and a large lower portion which penetrate downwards, so as to facilitate injection moulding, turning or milling in a powder metallurgy process; a mounting portion 18 is provided at the lower end of the fixed cutter body 11, and the outer diameter of a part below the waist portion 19 is increased, so as to facilitate the mounting portion 18 being provided outside, so as to avoid the hole diameter of the inner cavity being reduced at the position corresponding to the mounting portion 18, so that when the outer diameters of the waist portion and the upper portion of the fixed cutter are unchanged, the hole diameter of its internal cavity shall not be too small, so as to avoid affecting the movable cutter assembly, such as the production and assembly of the movable cutter assembly.

As shown in FIGS. 1 to 18, a cutter head assembly of a nose hair trimmer includes any one of the above-mentioned fixed cutter 1 and a movable cutter assembly located inside the fixed cutter 1, wherein the fixed cutter 1 includes a fixed cutter body 11, cutting teeth 12 are arranged on the fixed cutter body 11 at intervals in a circumferential direction, the cutting teeth 12 enclose a cutting cavity 13 for the inner movement of the movable cutter assembly, a hair inlet hole 14 is formed between the cutting teeth 12, the hair inlet hole 14 includes a narrow slot 141 located at a lower portion, and a wide opening 142 located at an upper portion which is wider than the narrow slot 141; the position of the narrow slot 141 is used for cutting hair corresponding to the blade in an internal rotation movement, and by providing the narrow slot 141 to cooperate with the blade, the safety of cutting is improved; when the fixed cutter 1 is moved in the nostril, including but not limited to rotating, swinging, and/or moving inside and outside, the wide opening 142 facilitates the entry of the nose hair, and when the nose hair enters the wide opening 142, the nose hair is easily moved further from the wide opening 142 into the narrow slot 141, thereby increasing the probability that the nose hair enters the cutting position to be cut.

The cutter head assembly of a nose hair trimmer further includes a housing 20 for mounting the fixed cutter 1.

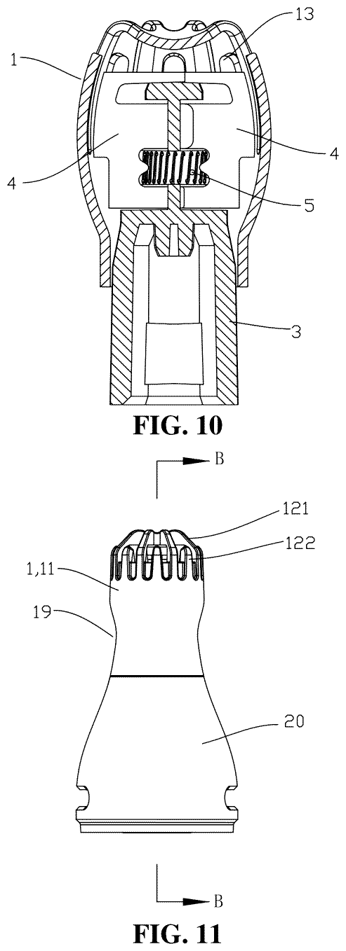

As shown in FIGS. 10, 14, 15 and 18, as an embodiment of the movable cutter assembly, the movable cutter assembly includes a plastic bracket or a movable cutter bracket 3, wherein a set of blades 4 is provided on the plastic holder or the movable cutter holder 3, each set having two left and right blades, an elastic structure is provided between the blades 4 for pressing each blade 4 to the side to elastically expand the blades 4 to the side, so that the blades 4 abut against the inner wall of the cutting teeth 12 to improve the acuteness of shearing, and the elastic structure is preferably a spring 5. Preferably, the cutting edge of the blade 4 has an angle of more than 10 to the narrow slot 141, one to improve the shearing performance, and the other to prevent the blade 4 from being caught in the narrow slot 141 by the spring 5.

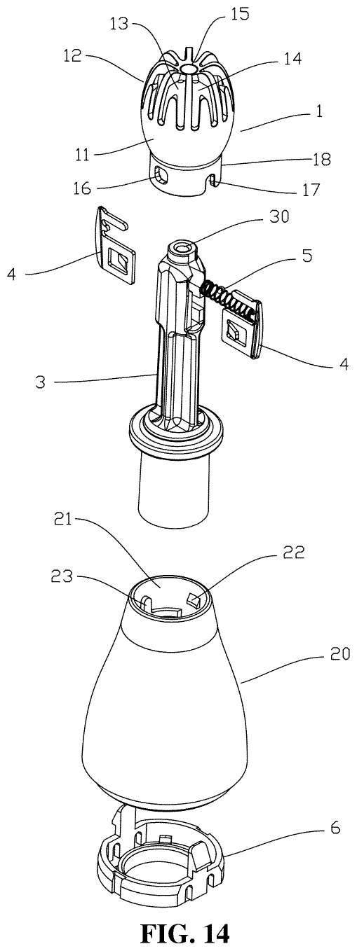

In order to confine the movable cutter assembly in the housing 20, as shown in FIG. 14, a locking member 6 may be provided in the housing 20 to confine the movable cutter holder 3 to prevent the movable cutter holder 3 from falling out of the housing 20.

The top of the fixed cutter 1 is provided with a net top 15, and a center positioning structure is provided between the net top 15 and the movable cutter assembly to enable the movable cutter assembly to perform center positioning when rotating, so as to improve the stability of the movable cutter assembly when rotating, so as to reduce the defects such as noise, murmur and jamming, and improve the shearing acuteness.

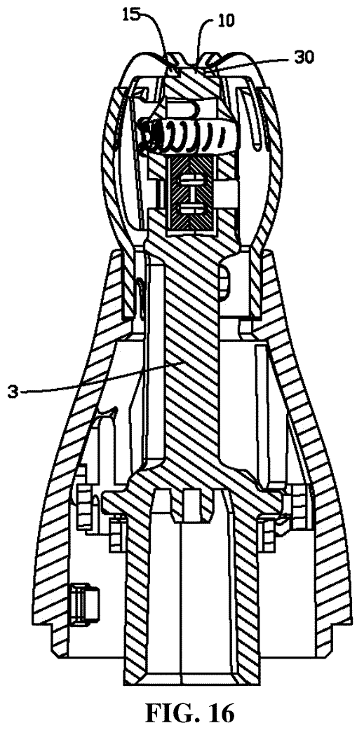

As a preferred embodiment of the center positioning structure, the center positioning structure includes a center positioning hole 30 and a positioning post 10 fitted between the net top 15 and the movable cutter holder 3. Specifically, as shown in FIGS. 14, 15 and 18, the net top 15 is provided with a positioning post 10 facing downwards, the movable cutter holder 3 is provided with a center positioning hole 30, and the center positioning hole 30 and the positioning post 10 are concealed inside, which has a simple structure; alternatively, in the embodiment shown in FIG. 16, the net top 15 is provided with a center positioning hole 30, and the movable cutter holder 3 is provided with an upward-facing positioning post 10.

Preferably, the fixed cutter 1 has smaller upper and lower portions and a larger middle portion. Another preferably, as shown in FIGS. 13 to 16, the middle and upper portion of the fixed cutter 1 is exposed above the housing 20, and the middle part of the fixed cutter 1 is larger than the upper portion of the housing 20, so as to form a narrowed neck below the head of the nose hair cutter head, and when the head of the nose hair cutter head with a cutter net is inserted into the nostril, the narrowed neck can be located at the position of the nostril opening, so as to facilitate better rotation and agitation at multiple angles in the nostril after the cutter net is inserted into the nostril, so as to better drive the nose hair into the narrow slot 141 for cutting.

In one embodiment of the fixed cutter 1, the mounting portion 18 of the fixed cutter 1 is provided with a snap hole 16 and a positioning groove 17, the upper end of the housing 20 is provided with an insertion groove 21 for the mounting portion 18 to be inserted from top to bottom, the insertion groove 21 is provided with a snap 22 protruding and used for snapping into the snap hole 16, and a positioning strip 23 used for inserting into the positioning groove 17. As shown in FIGS. 11 and 12, the outer wall of the fixed cutter 1 is preferably provided with a concave waist portion 19 which is located above the mounting portion 18 to facilitate its operative rotation within the nostril while facilitating connection with the housing 20 or main body 2 while avoiding interference with the movable cutter assembly.

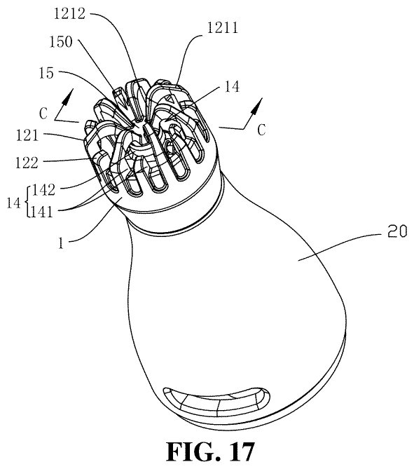

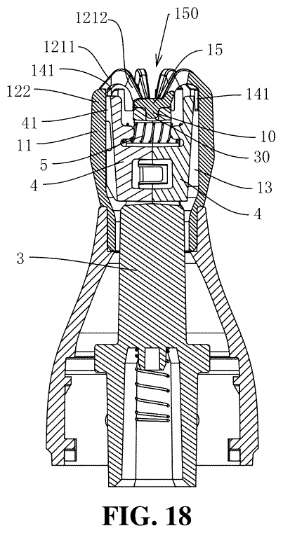

A preferred embodiment as shown in FIGS. 17 and 18, wherein a plurality of the cutting teeth are bent inward toward a central axis at their upper ends so that the respective cutting teeth are divided into a fixed cutter side section 1211 and a fixed cutter top section 1212, the inner ends of the fixed cutter top section 1212 being connected together by a net top 15, the fixed cutter top section 1212 being recessed downward with respect to the fixed cutter side section 1211 and enclosing a groove 150 recessed inward from top to bottom, and two adjacent the fixed cutter top sections 1212 are spaced apart to form a part of the hair inlet hole 14, so that the hair inlet hole 14 communicates with the groove 150, a side cutting edge 41 of the blade 4 for cutting hairs cooperating with the cutting teeth 12 is located between the fixed cutter side sections 1211 and the net top 15, and an upper end of the side cutting edge 41 of the blade 4 is higher than the net top 15. When trimming the nose hair, the fixed cutter is inserted into the nostril, and after the transverse growing nose hair enters the hair inlet hole, it can fall down through the concave groove, and when the nose hair falls on the net top and is stopped by the net top, it can easily fall into the cutting range of the side cutting edge, so that the nose hair can be cut off, and the efficiency of trimming the nose hair is improved.

The cutting tooth 12 includes a long cutter tooth 121 and a short cutter tooth 122, and the net top 15 connects a plurality of long cutter teeth 121 together.

A nose hair trimmer as shown in FIG. 1 includes a main body 2, the main body 2 is provided with a fixed cutter 1 of any one of the above-mentioned nose hair trimmers, the main body 2 is provided with a movable cutter assembly located in the fixed cutter 1, and the movable cutter assembly cooperates with a part of a cutting tooth 12 corresponding to a slot 141 to cut hair entering the narrow slot 141.

A power supply, a motor and a motor output shaft are provided inside the main body 2, and the motor output shaft is connected to the plastic holder 3 and drives the plastic holder 3 to rotate with the blade 4.

What is claimed is:

1. A cutter head assembly of a nose hair trimmer, comprising a fixed cutter (1) and a movable cutter assembly, wherein the fixed cutter (1) comprises a fixed cutter body (11), a plurality of cutting teeth (12) are provided on the fixed cutter body (11) at intervals in a circumferential direction, the cutting teeth (12) enclose a cutting cavity (13) for the movable cutter assembly to move inside, and a hair inlet hole (14) is formed between the cutting teeth (12), the hair inlet hole (14) comprises a narrow slot (141) located at a lower portion, and a wide opening (142) located at an upper portion which is wider than the narrow slot (141).

2. The cutter head assembly of a nose hair trimmer according to claim 1, wherein the cutting teeth (12) comprise a long cutter tooth (121) and a short cutter tooth (122), a plurality of short cutter teeth (122) are provided between two adjacent long cutter teeth (121), a head portion of the short cutter teeth (122) is a free end, and the hair inlet hole (14) is formed between the two adjacent long cutter teeth (121), wherein the short cutter teeth (122) form the narrow slot (141) with the adjacent long cutter teeth (121) or short cutter teeth (122) at left and right sides thereof, and the two long cutter teeth (121) form the wide opening (142) above the head portion of the short cutter teeth (122).

3. The cutter head assembly of a nose hair trimmer according to claim 2, wherein an upper end of the long cutter tooth (121) is bent inward toward a central axis and divides the long cutter tooth (121) into a fixed cutter side section (1211) and a fixed cutter top section (1212).

4. The cutter head assembly of a nose hair trimmer according to claim 3, wherein the fixed cutter top sections (1212) are connected together by a net top (15).

5. The cutter head assembly of a nose hair trimmer according to claim 4, wherein the short cutter teeth (122) are wider than the long cutter teeth (121).

6. The cutter head assembly of a nose hair trimmer according to claim 3, wherein the fixed cutter top section (1212) is downwardly concave with respect to the fixed cutter side section (1211).

7. The cutter head assembly of a nose hair trimmer according to claim 3, wherein the short cutter teeth (122) are shorter than the fixed cutter side section (1211).

8. The cutter head assembly of a nose hair trimmer according to claim 7, wherein the short cutter teeth (122) have their head portions facing inwards.

9. The cutter head assembly of a nose hair trimmer according to claim 1, wherein the fixed cutter (1) has smaller upper and lower portions and a larger middle portion.

10. The cutter head assembly of a nose hair trimmer according to claim 1, wherein a middle portion of an outer wall of the fixed cutter body (11) has a concave waist portion (19).

11. The cutter head assembly of a nose hair trimmer according to claim 1, wherein the cutting teeth (12) are provided with acute cutting edges (120).

12. The cutter head assembly of a nose hair trimmer according to claim 10, wherein the fixed cutter (1) is formed by powder metallurgy.

13. The cutter head assembly of a nose hair trimmer according to claim 1, wherein a net top (15) is provided at the top of the fixed cutter (1), and a center positioning structure is provided between the net top (15) and the movable cutter assembly for centering the movable cutter assembly when it is rotated.

14. The cutter head assembly of a nose hair trimmer according to claim 13, wherein the center positioning structure comprises a center positioning hole (30) and a positioning post (10) fitted between the net top (15) and the movable cutter holder (3).

15. The cutter head assembly of a nose hair trimmer according to claim 14, wherein the net top (15) is provided with a positioning post (10) facing downwards, and the movable cutter holder (3) is provided with a center positioning hole (30); or the net top (15) is provided with a center positioning hole (30), and the movable cutter holder (3) is provided with a positioning post (10) facing upwards.

16. The cutter head assembly of a nose hair trimmer according to claim 13, further comprising a housing (20) for mounting the fixed cutter (1), a middle upper portion of the fixed cutter (1) being exposed above the housing (20), and a middle portion of the fixed cutter (1) being larger than an upper portion of the housing (20).

17. The cutter head assembly of a nose hair trimmer according to claim 16, wherein the fixed cutter (1) is provided with a mounting portion (18) at a lower end, the mounting portion (18) is provided with a snap hole (16) and a positioning groove (17), the housing (20) is provided with an insertion groove (21) into which the mounting portion (18) is inserted from above to below at an upper end, the insertion groove (21) is provided with a snap (22) which protrudes and is used for snapping into the snap hole (16), and a positioning strip (23) for inserting into the positioning groove (17).

18. The cutter head assembly of a nose hair trimmer according to claim 13, further comprising a housing (20) for mounting the fixed cutter (1), wherein a middle portion of an outer wall of the fixed cutter body (11) has a concave waist portion (19), and the cutting cavity (13) is a straight hole or a hole with a small upper portion and a large lower portion penetrating downward, a lower end of the fixed cutter body (11) is provided with a mounting portion (18), and an upper end of the housing (20) is provided with an insertion groove (21) into which the mounting portion (18) is inserted from top to bottom, and the mounting portion (18) is inserted and fixed in the insertion groove (21).

19. The cutter head assembly of a nose hair trimmer according to claim 1, wherein the movable cutter assembly comprises a movable cutter holder (3) and a blade (4) mounted on the movable cutter holder (3), the blade (4) being attached to the inner side wall of the fixed cutter (1) and cooperating with the cutting teeth (12) when rotated to cut hair into the narrow slots (141).

20. The cutter head assembly of a nose hair trimmer according to claim 19, wherein a plurality of the cutting teeth (12) are bent inward toward a central axis at their upper ends so that the respective cutting teeth (12) are divided into a fixed cutter side section (1211) and a fixed cutter top section (1212), the inner ends of the fixed cutter top section (1212) being connected together by a net top (15), the fixed cutter top section (1212) being recessed downward with respect to the fixed cutter side section (1211) and enclosing a groove (150) recessed inward from top to bottom, and two adjacent the fixed cutter top sections (1212) are spaced apart to form a part of the hair inlet hole (14), so that the hair inlet hole (14) communicates with the groove (150), a side cutting edge (41) of the blade (4) for cutting hairs cooperating with the cutting teeth (12) is located between the fixed cutter side sections (1211) and the net top (15), and an upper end of the side cutting edge (41) of the blade (4) is higher than the net top (15).
